(19) United States
(12) Patent Application Publication
(10) Pub. No.: US 2014/0006138 A1
(43) Pub. Date: Jan. 2, 2014

(54) SYSTEMS AND METHODS FOR PROVIDING ADVERTISING

(71) Applicants: Daniel Corey Black, La Mesa, CA (US); David Baldo, La Mesa, CA (US); Wesley Oldaker, La Mesa, CA (US)

(72) Inventors: Daniel Corey Black, La Mesa, CA (US); David Baldo, La Mesa, CA (US); Wesley Oldaker, La Mesa, CA (US)

(21) Appl. No.: 13/799,061

(22) Filed: Mar. 13, 2013

Related U.S. Application Data
(60) Provisional application No. 61/666,922, filed on Jul. 2, 2012.
(60) Provisional application No. 61/720,439, filed on Oct. 31, 2012.

(51) Int. Cl. G06Q 30/02

(52) U.S. Cl. CPC G06Q 30/0251
USPC 705/14.41; 705/14.4; 705/14.58; 705/14.69

(57) ABSTRACT

Systems, methods and computer program products that provide digital and projection advertising solutions are described. In particular computer-based systems, methods, and programs for store-front, in-store or mobile displays that promote advertisements to consumers based on detectable or predefined conditions are described.

### CROSS REFERENCE TO RELATED APPLICATIONS

This application claims priority under 35 U.S.C. §119(e) to U.S. Provisional Patent Application Ser. No. 61/666,922, filed Jul. 2, 2012, entitled SYSTEMS AND METHODS FOR PROVIDING ADVERTISING, and U.S. Provisional Patent Application Ser. No. 61/720,439, filed Oct. 31, 2012, entitled SYSTEMS AND METHODS FOR PROVIDING ADVERTISING, the contents of which may be incorporated by reference herein in their entirety for all purposes.

### FIELD

This disclosure may be generally directed to systems, methods and computer program products configured to provide digital and projection advertising solutions. In particular, this disclosure relates to computer-based systems, methods, and programs for store-front, in-store or mobile displays that promote advertisements to consumers based on detectable or predefined conditions.

### BACKGROUND

The world of physical advertising lacks serious innovation. While online marketing has seen great strides in recent years with the ability to target marketing campaigns to specific consumers online, the physical advertising world has remained limited to static and inefficient advertising and marketing practices.

What may be needed may be an effective tool for driving physical traffic to small businesses.

### SUMMARY

The present invention applies to in-store and storefront digital and projection advertising solutions utilizing computer software and networking.

The present invention delivers the effectiveness and efficiency of Internet advertising and marketing methods to physical locations by enabling real-time delivery, deployment and management of these methods across connected media players creating a virtual advertising network.

The invention generally relates to real-time advertising systems and methods that provide five features.

A first feature relates to the representation, propagation, management, and scheduling of advertisement content on a media player from remote locations, and the deployment of this content in real-time remotely from various user interfaces to a display connected to media player in a physical location.

A second feature relates to the display of one user's advertisement or message on another user's display (e.g., a display of a store owner) participating in a profit, revenue, or other sharing model that allows businesses to turn their displays into public advertising space for profit, revenue, or other consideration. The invention advantageously enables advertising that utilizes computer software and networking to propagate this content to physical spaces, where it may be immediately displayed at those physical spaces once transferred to the media players.

A third feature relates to the creation of new modes and methods of interacting with advertising content in physical locations.

A fourth feature may be real-time advertising across a number of displays in a particular physical proximity utilizing a local network and/or spanning across a number of local networks, referred to as Extended Display.

A fifth relates to the tracking, compiling and analyzing of this advertising content and those interacting, whether physically or visually, with this content in these physical locations.

### BRIEF DESCRIPTION OF THE DRAWINGS

FIG. 1 illustrates a high-level drawing depicting a system involved in carrying out various aspects of the disclosure;

FIG. 2A illustrates a media player process.

FIG. 2B illustrates the initialization and execution of certain aspects of the media player program.

FIG. 3 illustrates aspects of the media player program.

FIG. 4 illustrates a process that may be performed by the render object.

FIG. 5 illustrates a render process that operates the media player's current playlist.

FIG. 6 which illustrates a notify process and an event process.

FIG. 7 illustrates certain processes to send and add new advertising content to a given media player.

FIG. 8 illustrates a process of adding advertising content.

FIG. 9 illustrates a process whereby advertising content may also be removed by the event process in the same fashion as adding new advertising content.

FIG. 10 illustrates an event process for adding a new schedule.

FIG. 11 illustrates a schedule process.

FIG. 12 illustrates the alarm process.

FIG. 13A describes a schedule file's format for a given day.

FIG. 13B describes a schedule file's format for events.

FIG. 14A illustrates the use of a mobile device to trigger targeted advertisements.

FIG. 14B illustrates an extended advertising display on one building using several discrete displays.

FIG. 14C illustrates an extended advertising display on several buildings using several discrete displays

### DESCRIPTION

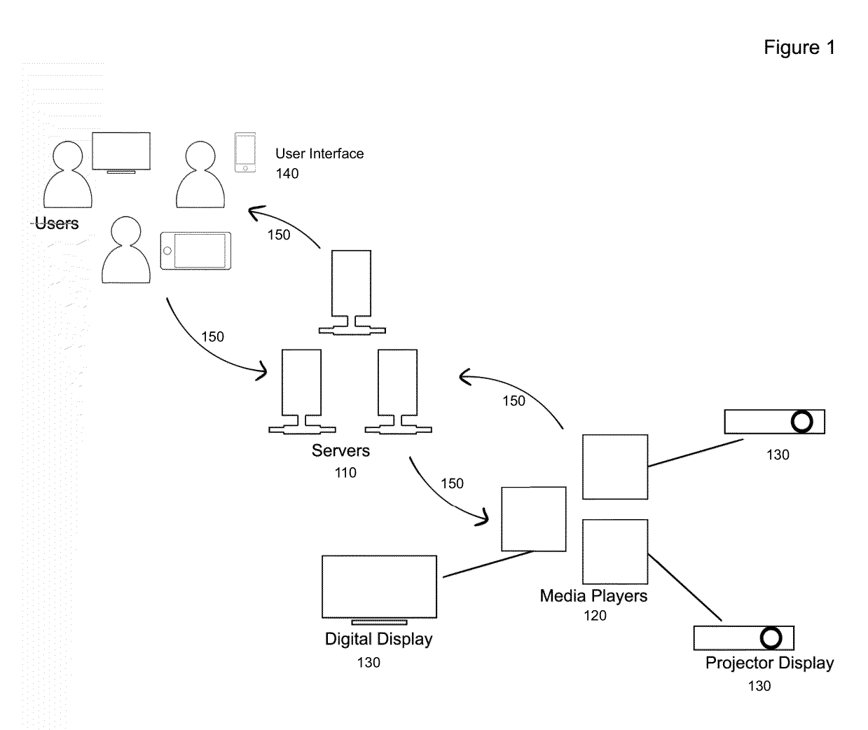

Attention is now drawn to FIG. 1 which illustrates a high-level process flow among various system components in which advertising content on a local or remote display connected to a media player in a physical location may be controlled, organized, managed, scheduled, updated, transferred, and shared across numerous devices and platforms.

FIG. 1 illustrates several system components. For example, one or more servers 110 handle requests to and from one or more users interacting with a user interface 140 via their respective user devices and one or more media players 120. Each media player 120 may be individually connected to one or more physical or virtual displays 130 in one or more physical locations to deliver advertising and marketing content in real-time. The individual components may be at the same physical location or divided among many individual physical locations communicating over one or more communication networks 150.

Example communication networks 150 may include a local network, satellite, broadband, internet, local area network (LAN), WLAN, Bluetooth, or other network communication hardware and software technology known in the art.

Continuing with FIG. 1, one or more user interfaces 140 permit a user to interact with a computing device via a screen, mouse, keyboard, touch, or other means for inputting and outputting information to or from the user interface 140. The user interface 140, or other input and output means may be referred to herein as a “UI” or user interface. Thus, the term “UI” or user interface may be used interchangeably with a user portal or client-side, as defined by a client-server relationship, or application. One or more users can interact with the UI 140 to control, organize, manage, schedule, update, transfer, and/or share advertising content on a display 130 from a local or remote computing device.

For example, but without limitation, users can upload, send, add, remove, or schedule content to be displayed on a media player 120 connected to the Internet or one or more networks 150. Activity on the client-side 140 may be handled by the server-side 110 and communicated bi-directionally via the network 150 back to the user interface 140 and to the media player 120.

The user interface 140 may be interacted with via a device which may include a display, a processor, memory, storage, network, input/output ports (e.g. USB, HDMI), and from which software may be executed (e.g., in a web browser or other applications). One of skill in the art may appreciate that the user interface device may include additional components, or may include only a subset of the above components. These various components may help facilitate communications between the user interface 140 and the other subsystems of FIG. 1.

With attention still drawn to FIG. 1, one or more servers 110 may receive and send requests to and from the user interface 140 via the communication network 150. User interface 140 may also communicate with one or more resources on a given server 110. Among these resources may be a data source that may be queried for data and in which data may be updated. The database may also store relevant information to identify and communicate with other resources and subsystems as shown in FIG. 1. Communication between servers 110 and media players 120 may be facilitated by the communication network 150.include.

As used herein, with respect to certain embodiments, the media player 120 may include, without limitation, a processor, memory, storage, network, input or output ports (e.g. USB, HDMI), and a power input, from which software may be executed to receive, send, manage, and render content to one or more displays to which it may be connected. In one embodiment, the media player 120 may use a multi-threaded program executed by a Linux operating system.

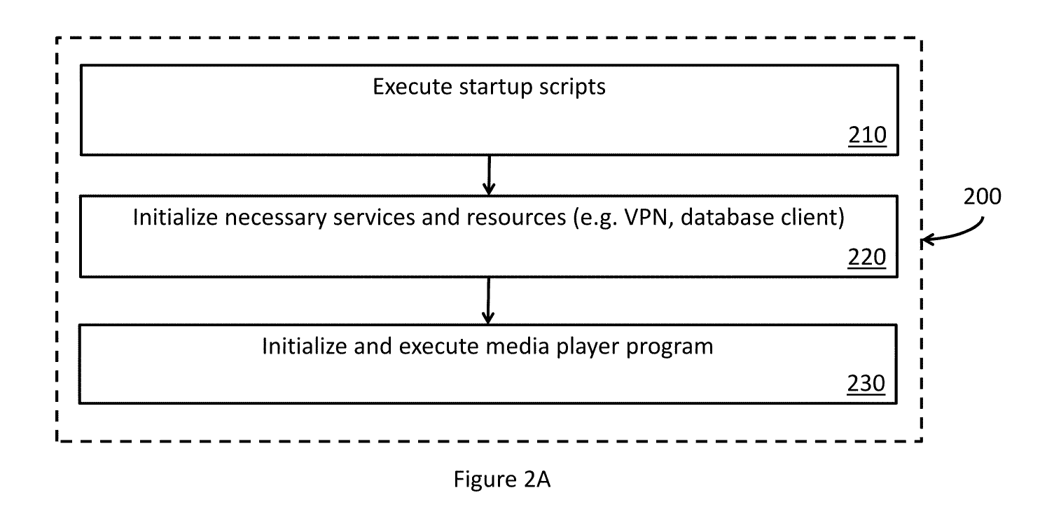

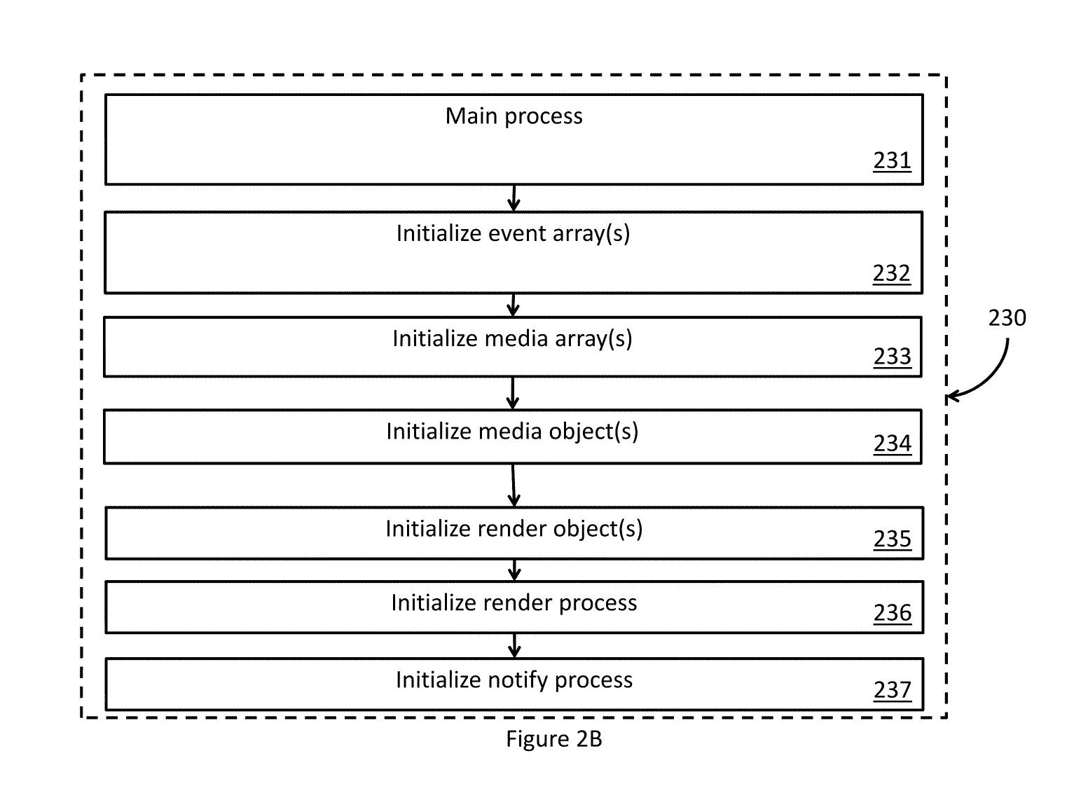

Attention is now drawn to FIG. 2A, which illustrates the process 200 executed by the media player 120. At stage 210, upon startup of the media player 120 200, the operating system may execute one or more startup scripts as needed to properly configure, manage, and monitor the media player 120. At stage 220, the startup scripts may initialize one or more necessary services or resources, including for example, but without limitation, a Virtual Private Network (“VPN”) client or a local database client. At stage 230, the startup scripts may initialize or execute media player program of the media player 120 200. The media player program may handle actions propagated from one or more servers 110 that may facilitate the controlling, updating, managing, monitoring, and scheduling of advertising content in real-time, locally or remotely.

Attention is now drawn to FIG. 2B, which illustrates the initialization and execution of certain aspects of the media player program of stage 230. At stage 231, the media player 120's main process starts either by execution from a startup script, user interface, scheduled execution, or by any other means known in the art. At stage 232, one or more event arrays may be initialized. At stage 233, one or more media objects may be initialized. At stage 234, one or more media arrays may be initialized. At stage 235, one or more render objects may be initialized. At stage 236, a render process may be initialized. At stage 237, a notify process may be initialized.

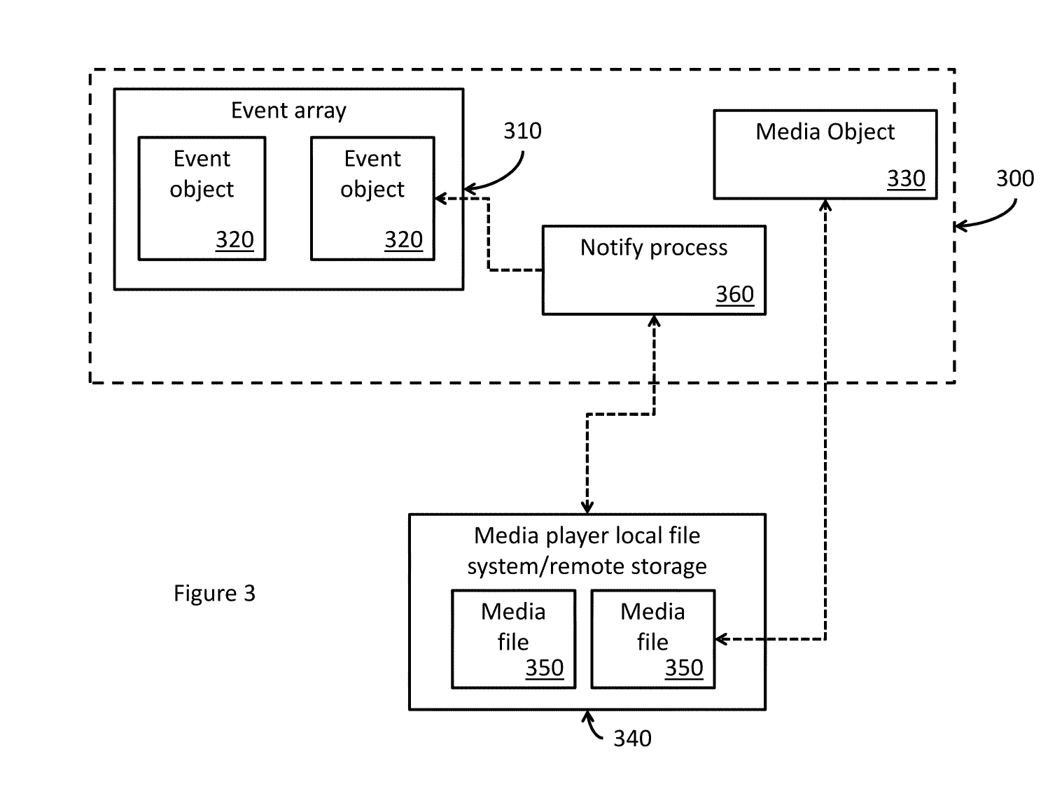

Attention is now drawn to FIG. 3, which illustrates aspects of the media player program. In a main process 300, one or more event arrays 310 may be used to hold one or more event objects 320. Each event object 320 represents a particular action, which may be associated with adding or removing advertising content on the media player 120's local file system or a remote storage location 340, which is accessible by the media player 120. These actions may include, without limitation, create, delete, and modify actions. A file system action may be detected by the media player 120's notify process 360 when a file is created, deleted, or modified in a particular folder.

Continuing with FIG. 3, one or more media objects 330 may represent one or more media files 350 which may include, without limitation, a static image, animated image, movie or video, interactive content such as a Flash file, or other multimedia content that may be transferred and stored on a media player 120's local file system 340. The media objects 330 encode and store information and data relevant to a particular media file 350. This information may include the media file's type, size, pixels, metadata, or any other relevant information that describes the file. One or more media objects 330 may be rendered to a display by the render process as described herein.

There may be one or more advertising playlists, which may contain specific types of media files or types of advertisements. Types of advertisements may include, without limitation, first-party advertisements, third-party advertisements, or event-driven advertisements. A first-party advertisement relates to an advertisement by a party that displays on a display 130 in operation at that party's business location. A third-party advertisement relates to an advertisement by a party that displays on a display 130 in operation at another party's business location. An event-driven advertisement relates to an advertisement by any party that displays on a display 130 in operation at any party's business location that may be triggered by interactions with this display, whether physical or visual or real-world events.

The media player 120 manages the advertising playlists by adding and removing types of advertisements to or from its respective playlist. This occurs when the media player 120 receives new media content or may be requested to update existing media content.

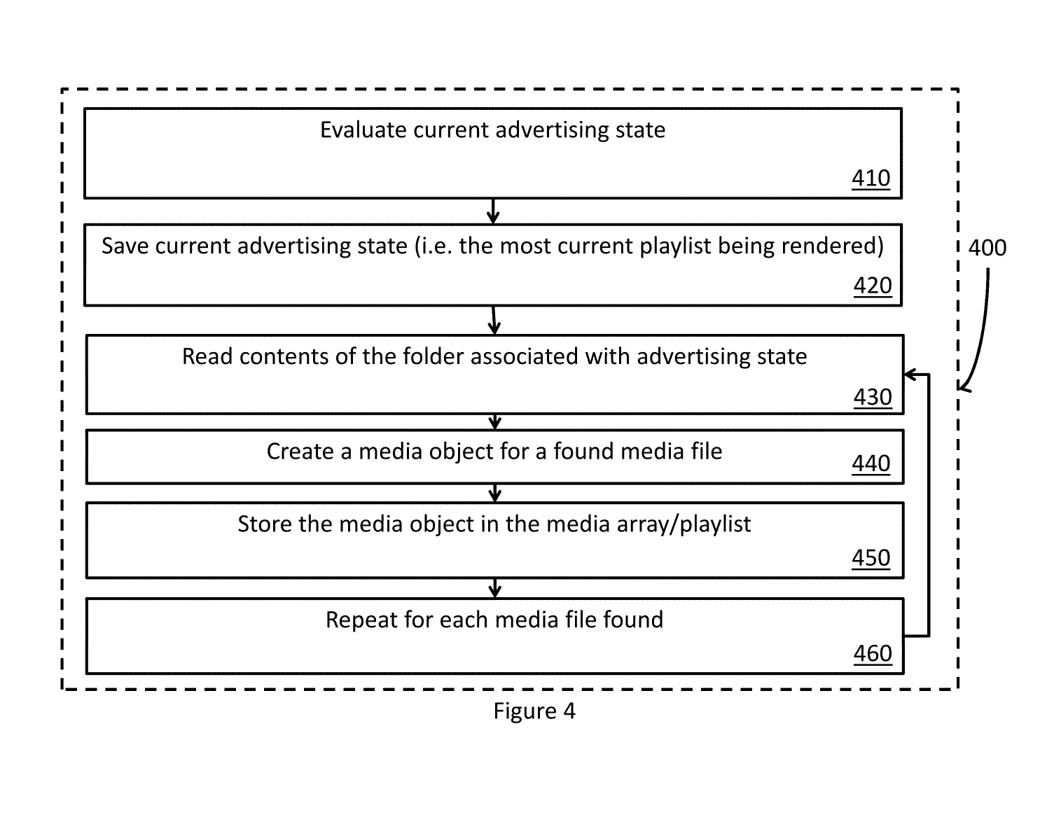

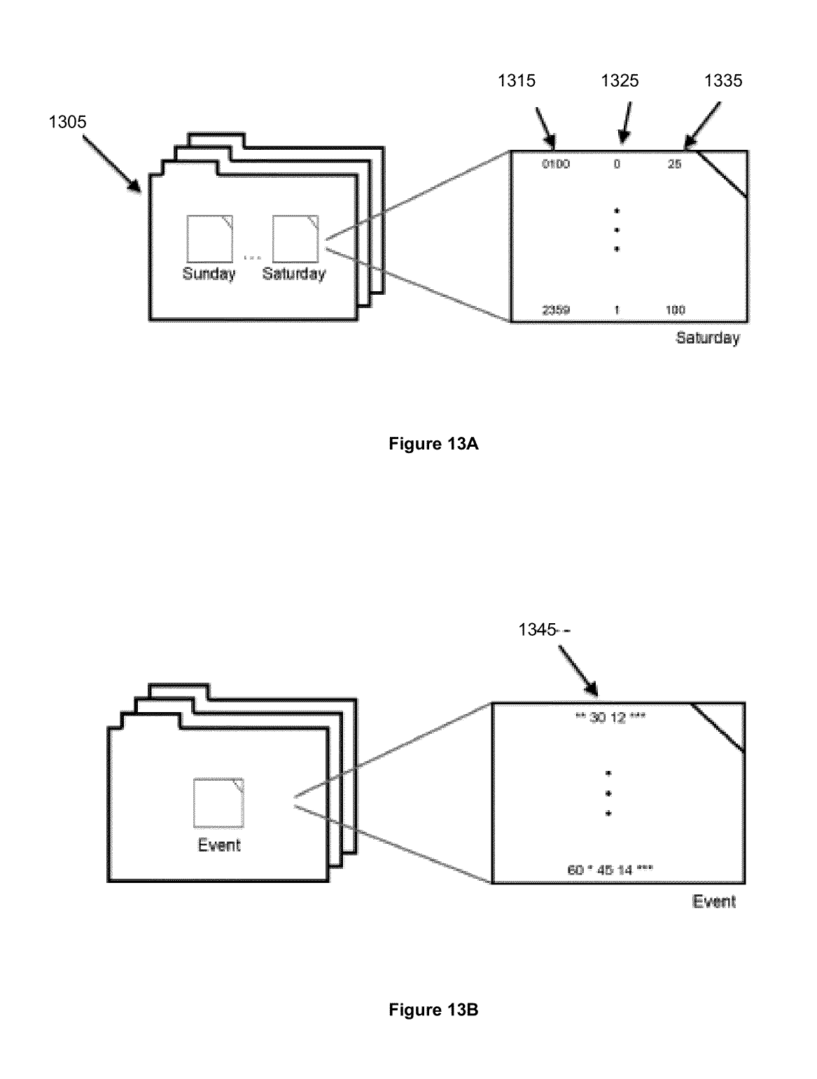

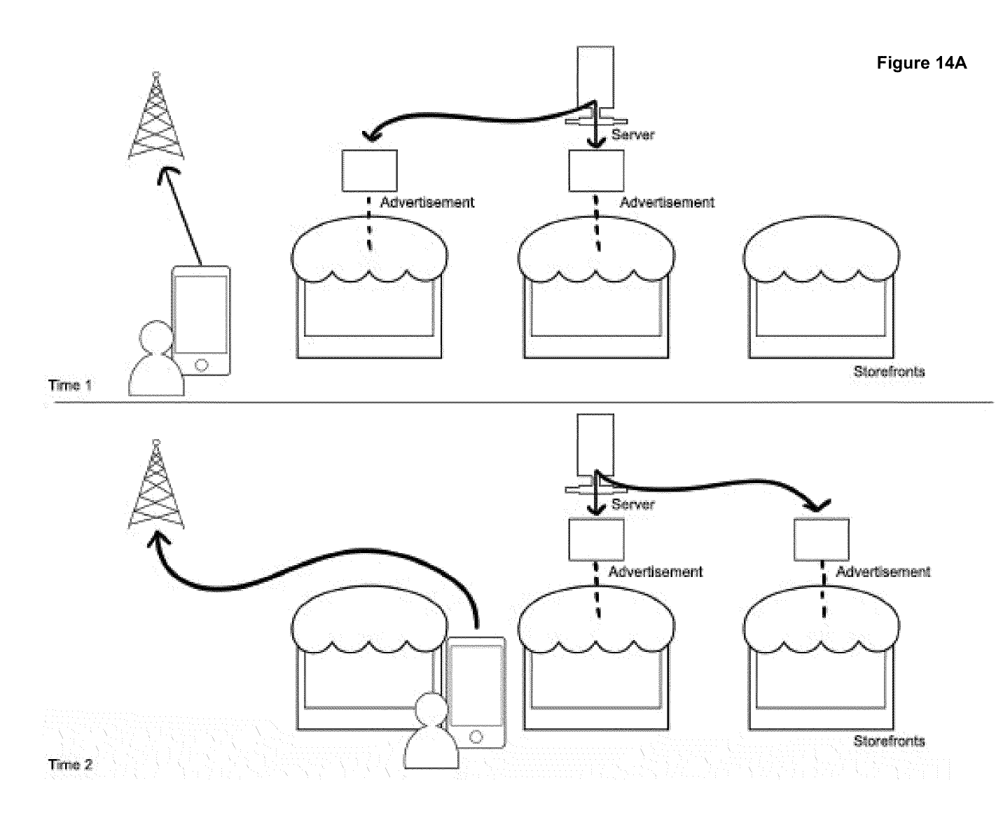

Attention is now drawn to FIG. 4, which illustrates a process 400 that may be performed by the render object. At stage 410, the render object evaluates its current state, also known as the current advertising state. The possible advertising states include idle, active and event state. Idle state represents the case where the render object is not currently displaying an advertisement (see 0 in FIG. 13A). The active state represents the case where the render object is currently displaying a first-party advertisement (see 1 in FIG. 13A). The event state represents the case where the render object is currently displaying a third-party or event advertisement (see FIG. 13B).

At stage 420, the render object saves its state to reflect the most current playlist being rendered. The active and event state correspond to the first-party and third-party or event playlist, respectively. Depending on the current state, active or event, the render object will process the playlist associated with this state. At stage 430, the render object reads the contents of the folder located on the media player 120's file system or in a remote storage location, which is associated with the particular advertising state. This folder, along with other folders, may be monitored by the media player 120's notify process so that a media object can be created when a new media file may be transferred and stored to the media player 120's local file system, or alternatively a remote file system. The monitored folders may include, without limitation, first-party, third-party, event, or schedule folders. First-party, third-party, and event folders, for example, may contain media content associated with first-party, third-party, and event advertisements, respectively, and may be monitored by the media player 120's render process so that media files may be added or removed to or from the respective playlists. The schedule folder also may be monitored by the media player 120's render process. Files in the schedule folder reflect the media player 120's current and future advertising schedule. The new media file's folder location represents that folder's respective playlist.

At stage 440, the render object creates a media object for each media file found. At stage 450, the render object stores each of these objects in a media array. At stage 460, the render object repeats this process to create the remaining playlists.

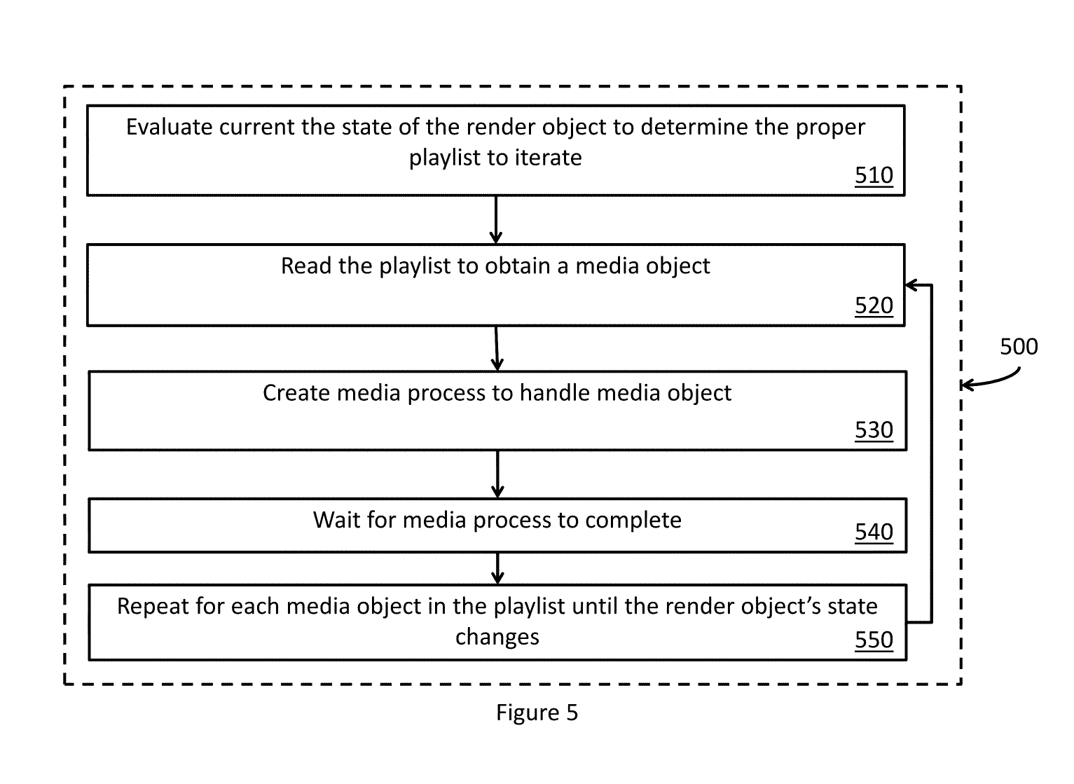

Attention is now drawn to FIG. 5, which illustrates a render process 500 that operates the media player 120's current playlist. At stage 510, the render process evaluates the state of the render object to determine the proper playlist to iterate. At stage 520, the render process reads from the playlist to obtain a media object in the playlist. At stage 530, the media object may be evaluated and a media process may be created to handle the media object. The media process may be further described elsewhere herein. At stage 540, the render process sleeps for the duration of this advertisement represented by the media object. At stage 550, the render process repeats for each subsequent media object in this playlist until the render object's state changes.

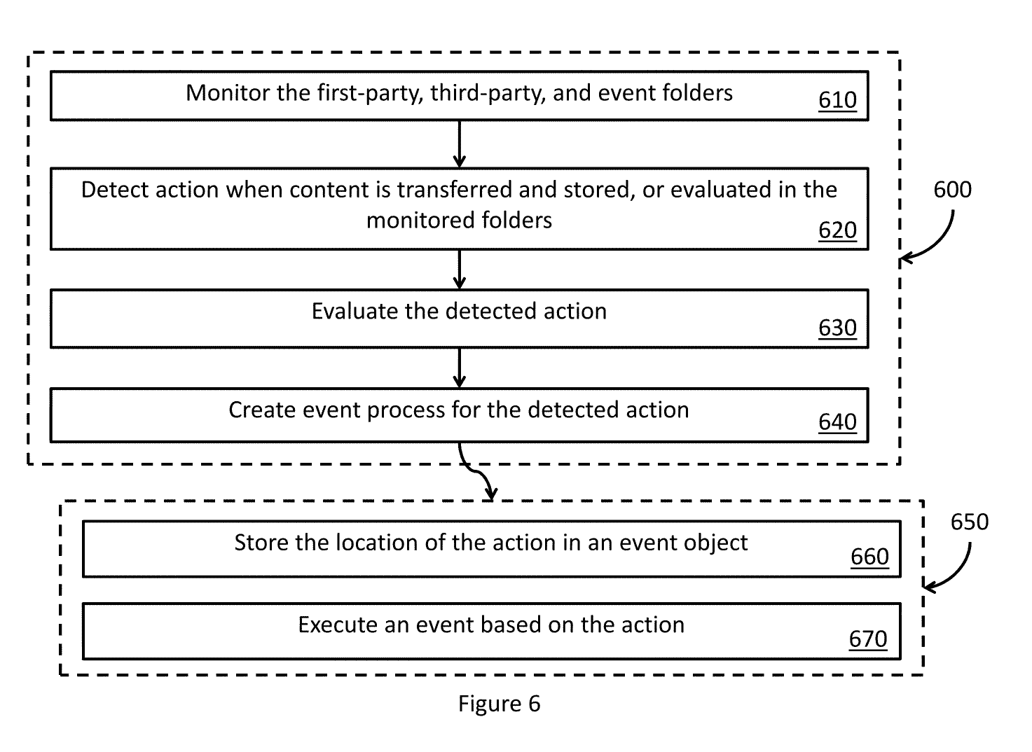

Attention is now drawn to FIG. 6, which illustrates a notify process 600 and an event process 650. At stage 610, the notify process monitors the first-party, third-party, and event folders. At stage 620, the notify process detects an action when a file is created, deleted, or modified in any of the monitored folders. At stage 630, the action may be evaluated. At stage 640, the notify process creates an event process 650. At stage 660, the event process evaluates the action further and stores the location of this action in an event object. At stage 670, the event process executes an event based on this action.

Advertising content may be uploaded to one or more servers 110 through a user's computing device. The advertising content may be stored on one or more servers 110 and uniquely identified in one or more databases so the advertising content may be accessed by other devices. One or more servers 110 may handle requests to send advertising content to one or more media player 120s, which may be transferred to the media player 120 utilizing existing standard network protocols such as SFTP, FTP, TCPIP, HTTP, streaming, or any other network or internet protocols, or other means of transferring content or files from one device to another. When the advertising content may be transferred and stored on a media player 120's local file system or a remote storage location that is accessible, the notify process 600 may detect a create and/or modify action. After either action, a new file may be created on the media player 120's file system, and data may be written and saved in this file thus modifying the file.

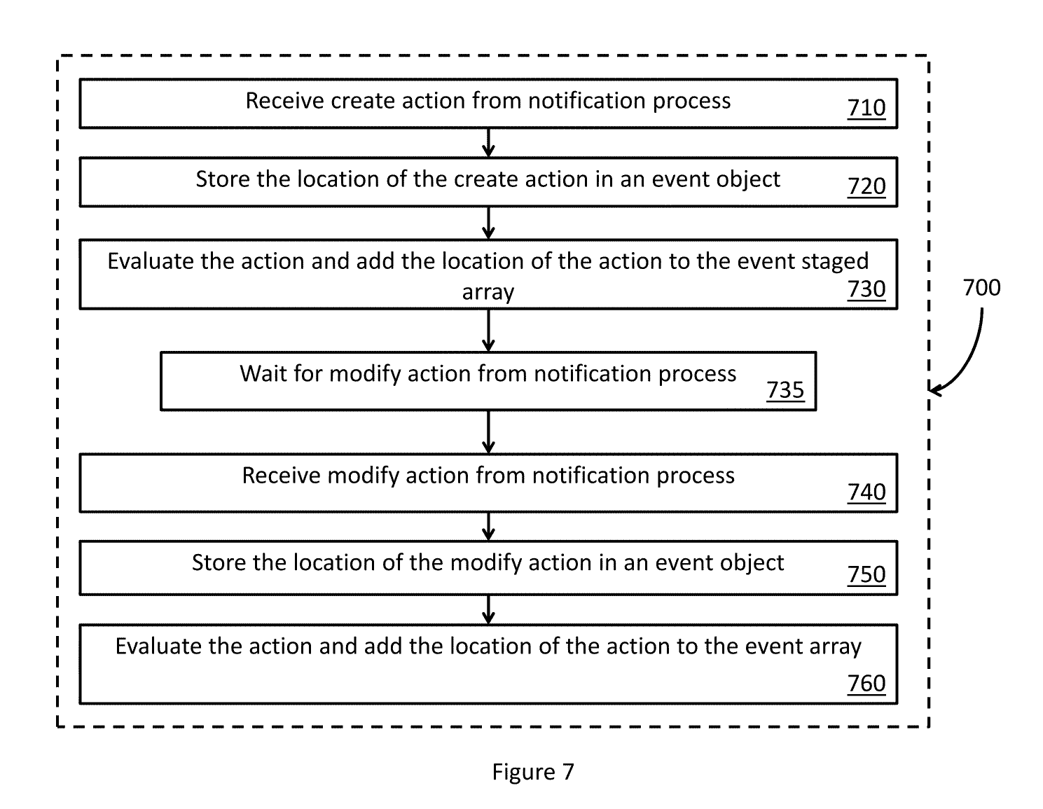

Attention is now drawn to FIG. 7, which further illustrates an event process 700 when receiving create and modify actions from the notification process. At stage 710, the create action may be first sent by the notification process and received by the event process 700. At stage 720, the event process stores the location of the create action in an event object. At stage 730, the event process evaluates the action and adds the location of the action to the event-staged array, a temporary array to save the create action since a modify action is received from the notification process simultaneously. At stage 735, the event process waits for the modify action to be sent from the notify process. At stage 740, the event process receives the modify action which is then received by the event process. At stage 750, the event process stores the location of the modify action in the event object. At stage 760, the event process evaluates the modify action, and adds the event object to the event array.

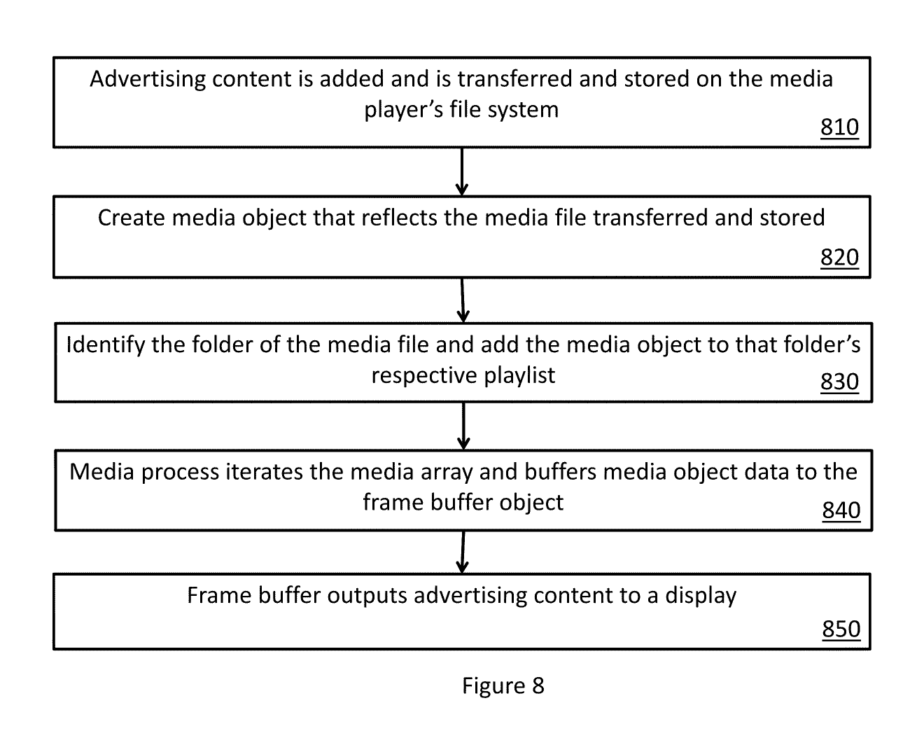

Attention is now drawn to FIG. 8, which illustrates a process 800 of adding advertising content. At stage 810, advertising content may be added through a user interface and then transferred and stored on the media player 120's local file system, or in a remote storage location accessible by the media player 120. At stage 820, a media object may be created to reflect the media file that was transferred and stored. At stage 830, the media object may be added to its respective playlist by identifying the folder containing the media file represented by the media object. At stage 840, the media process iterates the media array, buffering bytes of image data of a media object to the frame buffer object. The frame buffer object provides an interface to the graphics hardware and display. At stage 850, the frame buffer may output advertising content to a display. It is noted that the render process may determine when to create a media process by evaluating its state and its respective playlist.

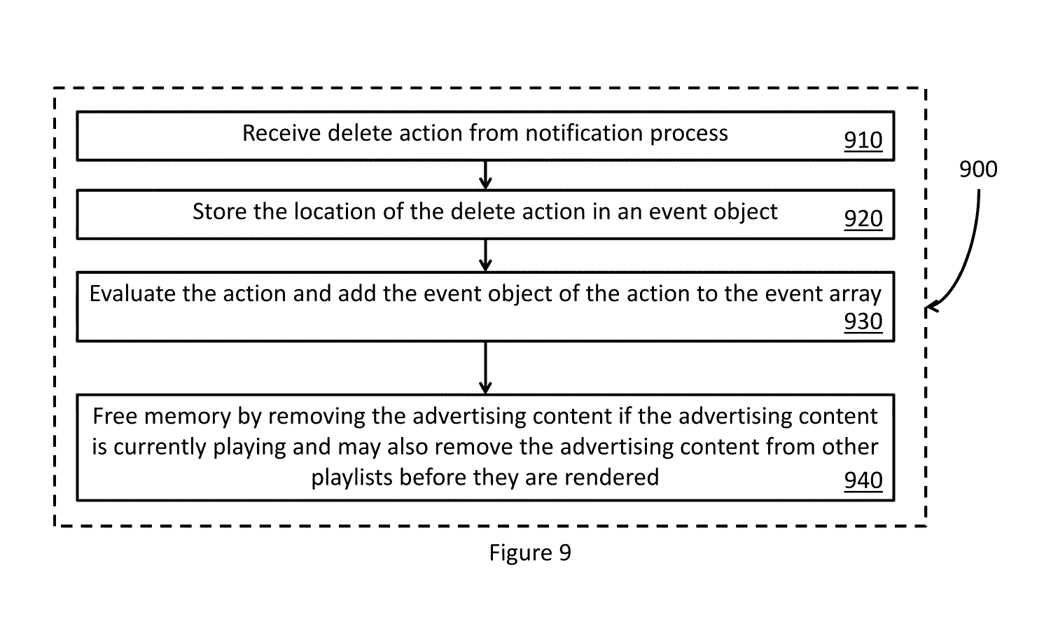

Attention is now drawn to FIG. 9, which illustrates a process 900 whereby advertising content may also be removed by the event process in the same fashion as adding new advertising content. When advertising content may be removed from the media player 120, the notify process detects a delete action. At stage 910, the event process receives the delete action from the notification process. At stage 920, the event process stores the location of the delete action in an event object. At stage 930, the event process evaluates the action, and adds the event object to the event array. At stage 940, the event process may free memory allocated for the advertising content if the advertising content is currently playing, and may remove the advertising content from other playlists before these playlists may be rendered.

The media player 120 may schedule ads on a recurring basis such as daily, weekly, monthly, etc. The media player 120 may also schedule event-driven advertisements that occur at a specific time, during a particular event or as defined by one or more programmatic rules. When a new schedule may be propagated from a host such as a server 110 or a user interface device 140, this schedule may be stored in its respective folder.

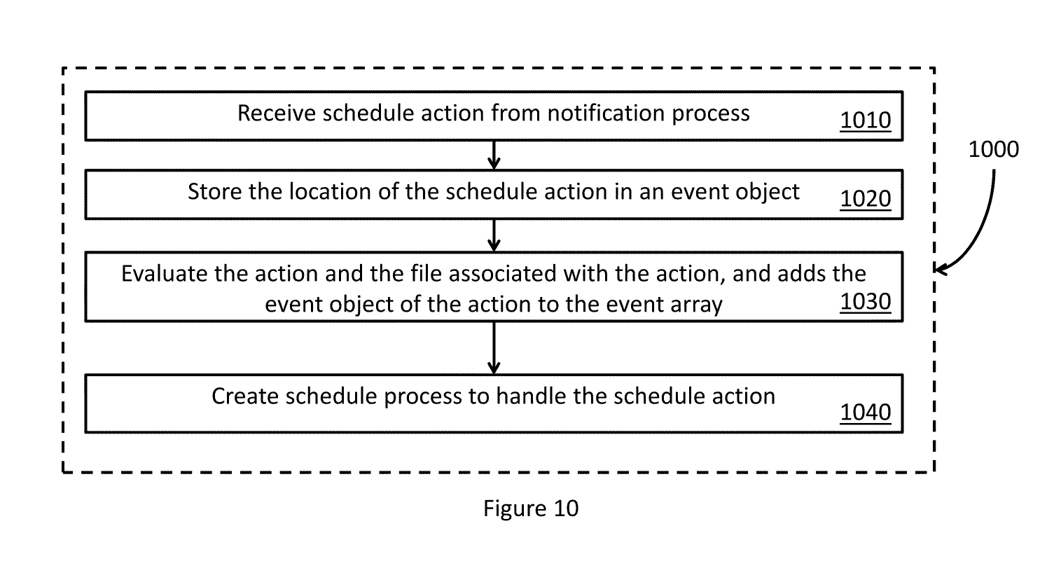

Attention is now drawn to FIG. 10, which illustrates event process 1000 for adding a new schedule. At stage 1010, the event process receives the schedule action from the notify process. At stage 1020, the location of this schedule action is stored in an event object. At stage 1030, the schedule action and the file associated with the schedule action is evaluated. At stage 1040 a schedule process is created to handle the schedule action.

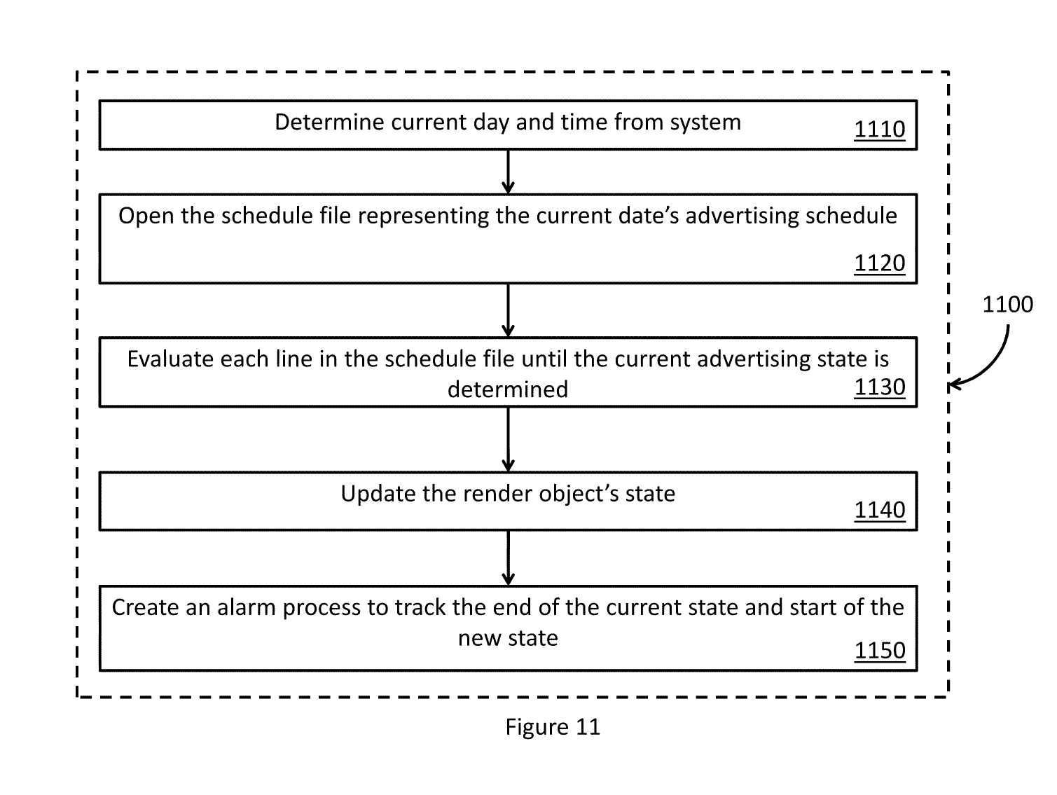

Attention is now drawn to FIG. 11, which illustrates a schedule process 1100. At stage 1110, the schedule process determines the current day and time as defined by the system's time. At stage 1120, the schedule process opens the file representing the current day's advertising schedule. Stage 1130 evaluates each line in the schedule file (and preceding files, if necessary) until it determines the current advertising state. Upon determining the advertising state, stage 1140 updates the render object's state. Stage 1150 creates an alarm process to signal an advertising state change.

Attention is now drawn to FIGS. 13A and 13B. FIG. 13A illustrates an advertising schedule file 1305 format for a given day. The first value 1315 represents hours and minutes in military time. The second value 1325 represents the advertising state at this time. If this advertising state is active or event, a percentage of advertising may be provided. The third value 1335 represents the percentage of advertising during this the state 1325 and time 1325. For example, if the percentage of advertising is 75 for active state, then 75 percent of the advertising time is allocated for first-party advertisements and the remaining 25 percent is allocated for third-party advertisements. FIG. 13B illustrates a schedule format 1345 for a number of events. This format utilizes a cron format.

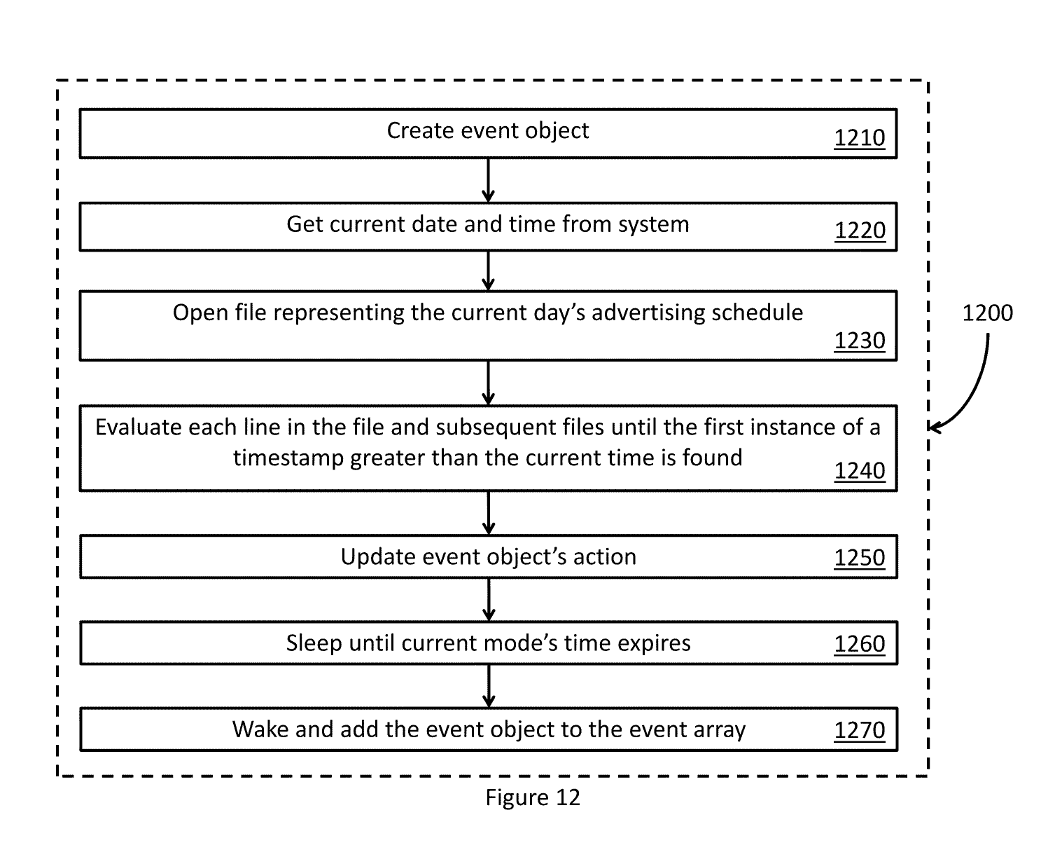

Attention is now drawn to FIG. 12, which illustrates an alarm process 1200. The alarm process signals an advertising state change. At stage 1210, the alarm process creates an event object. At stage 1220, the alarm process gets the current day and time. At stage 1230, the alarm process opens the file representing the current day's advertising schedule. At stage 1240, each line in advertising schedule file (and subsequent files, if necessary) is evaluated to find the first instance of a timestamp greater than the current time. This greater timestamp represents the next state of advertising and the time when this next state starts. At stage 1250, the event object's action is updated. At stage 1260, the alarm process sleeps for the remainder of the current state's time and fires a signal when this duration reaches 0 so the program knows when its current advertising state changes. At stage 1270, when this duration reaches 0, the thread wakes up and adds this event object to the event array, repeating this alarm process for the subsequent advertising state.

The media player 120 updates, manages, and schedules advertising in a way that advantageously enables one party to advertise on a display 130 at another party's location. Accordingly, any advertisement may be delivered to a display 130 at any location regardless of who originated the advertisement content. In some cases, a party may provide their physical space to third-party advertisers. The ability to advertise at another location provides businesses with a hyper-local advertising method, which enables the targeting of advertisements to new audiences in certain locations, as well as maximizing exposure for these advertisements locally. Businesses that close earlier in the day may advantageously generate revenue from their physical location by displaying advertisements for other businesses after closing. Additionally, targeted advertisements are made possible based on tracking of conditions (e.g., when a crowd exits an event, when an individual with predefined interests is nearby as determined based on location technologies), and then promoting advertisements at a location near consumers associated with the condition, where the advertisement may specify a different business than where the advertisement displays.

Other advantages include setting different levels of costs for advertising based on conditions, locations and other considerations (e.g., whether the advertisement is a first-party or third-party advertisement)

The media player 120 operates its advertising schedule to reflect several use cases.

First, it may dynamically allocate a percentage of advertising time and space for first-party, third-party, and event advertisements. This advertising schedule considers certain times of a day, week, month, or year where a business may or may not want to advertise on their display, but provide this time for other advertisers. This may be the case when first-party, third-party, and event advertising allocation may be divided among its advertisers.

Second, the media player 120's advertising schedule may also be coordinated by the results and behavior of a real-time bidding platform for specific advertising space, or space in a particular advertising segment that an advertiser may participate in to effectively target certain audiences, and optionally at a particular time. Advertisers may participate in one or more advertising segments, which may be categorized by types of businesses, industries, products, and other categories. Prices may vary for certain physical advertising spaces and networks that may consider key performance indicators, as well as real-time physical metrics and analytics.

Third, a particular advertising schedule may reflect filtered advertising content from one or more advertisers in one or more advertising networks. This filter system may allow a businesses with a display 130 to prohibit advertisements offered by competing businesses from displaying via the display 130. The filter may rely on designators like business names, types of products or other categories associated with an advertisement or advertiser

Additional advantages include creation of new modes and methods of interacting with advertising content in physical locations. The present invention utilizes Quick Response codes (“QR codes”) and provides a platform for creating, managing, updating, and organizing dynamic QR codes used in physical locations. These dynamic QR codes provide users and businesses with the ability to link a number of daily deals, forms, and/or other web-based content to a typical QR code, which may be propagated to a media player 120 in real-time. The platform also provides users and businesses with a means of gathering analytics, as well as measuring the effectiveness and efficiency of advertising content linked to these codes in physical locations. One example may include, without limitation, when a viewer scans a QR code advertising a daily deal on a display connected to a media player 120, the viewer may be redirected to a URL that communicates with the particular media player 120 to remove a daily deal from the current display after it has been captured on the viewer's phone.

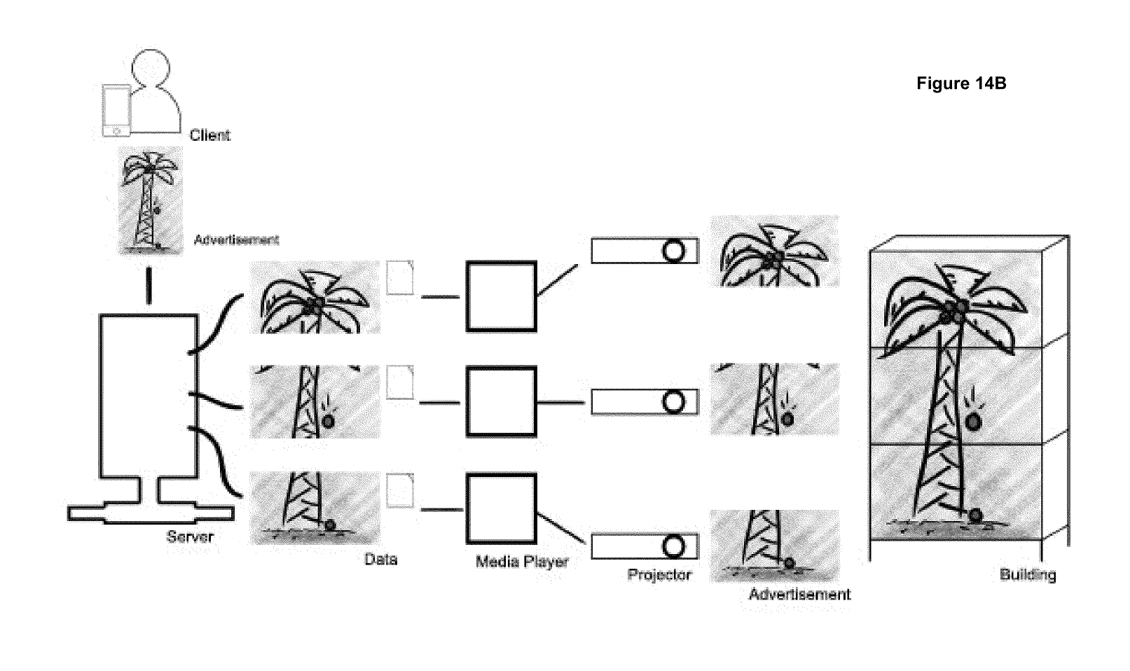

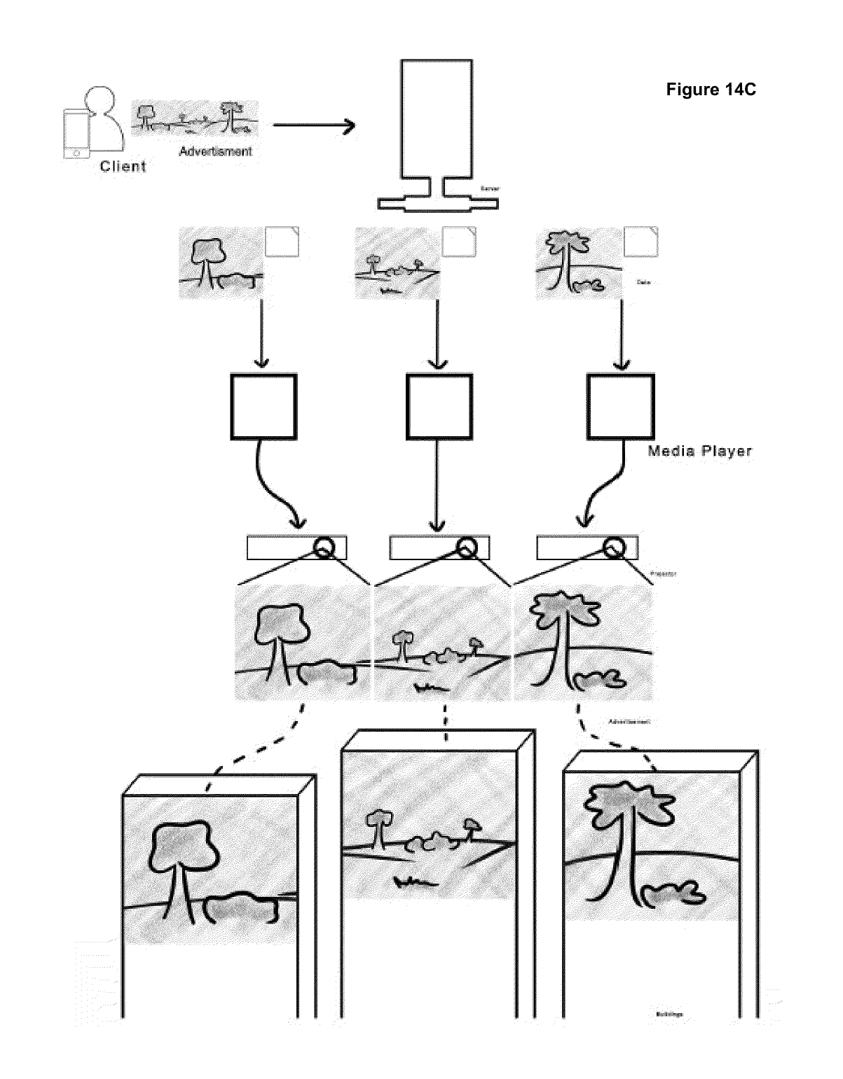

The present invention facilitates the sharing of advertising content like daily deals by integrating existing mediums and technologies which may include, without limitation, social media platforms, SMS, email, and others, into an all-encompassing application that may be accessible across numerous user interfaces. The system allows users to share advertising content on a display. The application may utilize a broadband, satellite signal, or any other means known in the art to get the viewer's current location, and compare this location to the location of the display. If these locations may be close enough (i.e., the viewer may be standing near the display), the advertisements on a display 130 may be readily available to the viewer's mobile or tablet device, which the user may share across these medium and technologies. The application may also utilize the viewer's location to show targeted advertising content to the viewer when the viewer approaches a particular display (see FIG. 14A, time 1, first display from the left), and to remove targeted advertising as the user moves away from a particular display (see FIG. 14A, time 2, first display from the left).

In addition to these new modes and methods of interacting with advertising content on these displays, integration into existing touchscreen display technology such as resistive, capacitive, infrared, or any other touchscreen technology known in the art is contemplated.

By utilizing a network of media player 120s, an extended display may be formed by utilizing several discrete displays. By way of example, without limitation, an entire hotel building or three separate buildings may be converted into one extended display (see FIGS. 14B and 14C, respectively). Content may be propagated from a user interface device 140 to a server 110, which crops the content accordingly and sends the cropped content and schedule data to the appropriate media player 120. Each media player 120 may independently schedule the content so that remote displays 130 may collectively display a single image.

The driver of in-depth and effective analytics for this system will be the use of tracking databases, a data warehouse, a custom Application Programming Interface (API) and custom or third-party reporting tools. Every advertisement impression may be logged in a local database on a media player 120, wherein impressions may be tracking using location technologies to track users who passed the advertisement (e.g., NFC and other near-range detection technologies). Tracking information may be transmitted to a central tracking database on a daily, hourly, or smaller interval. An Extract, Transform and Load (ETL) Tool will ingest new or modified data from the tracking database, process the data by dimensionalizing it into business relevant metrics and dimensions and insert it into a data warehouse. The custom API may provide simple functions to retrieve aggregated metrics relevant to companies, stores, devices, networks, and other business relevant levels and supply them to our custom reporting dashboards. Additionally, third-party reporting tools may be used to ingest data from data warehouses, compress the data, and display the data through manually built reports. Along with impressions, this system may track physical foot and vehicle traffic and provide real-time metrics pertaining to the visibility and popularity of a given display by utilizing existing third-party physical analytics solutions.

This information may also be ingested into a data warehouse for reporting and analytic purposes. Finally, the use of mobile applications may allow physical traffic to interact with various impressions that may be built for such interaction. Information about the customer interacting and the interaction may be stored in this warehouse for analytics based from demographics to interaction choices. These interactions may be tracked and ingested into the data warehouse.

The present invention's tracking infrastructure may provide many useful reporting and analytic functions. Through the use of the physical tracking metrics, the system permits the identification of windows that have the highest traffic and can raise or lower prices per impression respective to the traffic and other variables such as type of traffic (i.e. pedestrians versus vehicles), time of day, hyper-local events, etc. In addition, tracking of physical interaction with displays through SMS, QR codes, touch interaction, and other forms of consumer interaction can be leveraged through the data warehouse, including circumstances where a particular consumer interacts with a series of advertisements while the consumer travels from one location of a display 130 to another location of another display 130, and so on.

With this information, users may gain insight on business trends based on interaction with their displays, to drive traffic and other business improvements. Consequently, these metrics may also be used to track display traffic and will affect impression price for the third-party network. The infrastructure may provide precise reports into the daily functioning down to the granular level of individual displays up to the highest level of all impressions.

### Additional Aspects

One or more aspects may relate to systems, methods, and computer program products comprising a non-transitory computer usable medium having a computer readable program code embodied therein that is adapted to be executed to implement method steps to: select a first remote display at a first location from among a plurality of remote displays corresponding to a plurality of locations; select a first advertisement from a plurality of advertisements; and cause the first remote display to display the first advertisement.

In accordance with some aspects, the first location relates to a first business, the first advertisement is associated with a second business, and a data source stores the advertisement data corresponding to the plurality of advertisements.

Additional method steps may be adapted to: determine, prior to causing the first remote display to display the first advertisement, if the second business competes with the first business.

Additional method steps may be adapted to: display a code with the first advertisement, where the code is associated with goods or services offered by a business; detect whether a consumer used the code to obtain the goods or services offered by the business; and cause, upon determining that the consumer used the code to obtain the goods or services offered by the business, the first remote display to display a second advertisement.

Use of the code may include redeeming the goods or services with the code by visiting a web-based or physical location operated by the business. Codes may also be related to activities by the consumer in relation to the business apart from obtaining goods or services, including, for example, completing surveys, setting up an account, interacting with other consumers in association with the business, and other activities. The data source may store an indication regarding whether a code is “active” (i.e., whether the code may still be displayed). Active codes may be associated with single uses or multiple uses by consumers. The codes may also be used to encourage interaction with advertisements in the system by requiring a consumer to scan multiple codes at multiple displays in order to obtain some benefit (e.g. a discount or other benefit). In such an embodiment, each scan of a code may provide details to the consumer as to where the next code is located. In this manner, gamification of advertisement viewing/interaction is possible. The codes may also simply deliver additional information to a consumer's smart phone or other mobile computing device, or to a web-accessible account affiliated with the consumer (where the user can access the account from any type of computing device).

Additional method steps may be adapted to: determine, prior to selecting the first advertisement and selecting the first remote display, a first position of a consumer; select the first remote display based on the first position; and select the first advertisement based on a characteristic of the consumer. A consumer characteristic may include any type of consumer information available to the system, including online personal data, historical buying habits, and social media information (e.g., postings, interest), among other data that might be used to match content of an advertisement to the consumer.

Additional method steps may be adapted to: track, prior to selecting the first remote display, a consumer's position during a first period of time; select the first remote display based on the tracking of the consumer's position during the first period of time; track the consumer's position during a second period of time; select a second remote display based on the tracking of the consumer's position during the second period of time; cause the second remote display to display the first advertisement or a second advertisement based on the tracking of the consumer's position during the second period of time; and cause the first remote display to not display the first advertisement based on the tracking of the consumer's position during the second period of time.

The system may track the position of the consumer to determine if the consumer is approaching a display, or if the consumer is nearby the display (e.g., within a certain threshold distance such as a predefined number of units of measure). Tracking may involve determine a single position of the consumer, or a series of positions of the consumer, before selecting advertisements and/or displays.

A random advertisement or a related advertisement may be selected as the second advertisement. For example, selection of the second advertisement may depend on whether the consumer interacted or failed to interact with the first advertisement, whether it is assumed that the content of the first advertisement was ineffective at gaining the consumer's attention, the time of day (e.g., meal time, morning, evening), proximity of the consumer to the business, knowledge of the consumer characteristics, atmospheric conditions (e.g., rain, temperature), or other considerations. The related advertisement may be selected (compared to the first advertisement) because it displays similar or different content, provides the same content but in a different way, promotes the same business, promotes a similar business, or provides some other preferred quality.

Additional method steps may be adapted to: select the first display based on a detected condition, including the closing of a venue having consumers in attendance. The detected condition may include: an ending time associated with a nearby consumer gathering (e.g., closing time relating to an entertainment venue like the theatre or a sporting event, closing time associated with a particular type of social gathering place like a restaurant or club); a location of the consumer gathering with respect to locations of available displays as they relate to direction of traffic and locations of transportation; a type of consumer gathering (e.g., one that has definable characteristics that can be used to select an advertisement); and other conditions.

Additional method steps may be adapted to: associate a cost to the display of the first advertisement on the first remote display, wherein the cost is a function of one or more factors. The factors may include time of day, location of display (e.g., in relation to target consumers), existence of other advertisements, time period during which the advertisement is displayed, the business who operates at the location of the display, and other factors.

In accordance with at least some embodiments, program execution may be accomplished using: Tiny Core Linux (Base 4.5.3) or Ubuntu server (Ubuntu server 11.10 i386); Bodhi 2.0.0; Python 2.7; MPlayer; Apache HTTP server (apache2) or Python (python2.7); PHP (php5) or Python (python2.7); GNU C Library (libc6)′; GNU Standard C++ Library (libstdc++6); curl (FROM curl.haxx.se, NOT curl.com); Image Magick (libmagickcore3); MongoDB (mongodb-dev); X11 a.k.a. the “X Window System” (x11-common). In accordance with at least some embodiments, program build may be accomplished using: Make; bash; apt; pkg-config; gcc; g++; autoconf; automake; libtool; zlib; Image Magick (libmagickcore3); giflib; GNU C Library (libc6); GNU Standard C++ Library (libstdc++6); tar; gzip. Optional libraries in accordance with certain embodiments may include: zlib (zlib1g); libjpeg (libjpeg8); libpng (libpng12-0).

### Glossary

One of skill in the art will appreciate that the following terms may take on any meaning known in the art. However, in accordance with certain embodiments, but not all embodiments, the following terms may be defined as follows:

Alarm Process—parses and evaluates schedule file, setting a timer of when the current “state” ends.

Client-side—the operations performed by the client's computer as defined by a client-server relationship.

Client-side relationship—the client may be a computer program such as a web browser that allows a user to send requests to a server and receive responses from this server based on user input.

Cronjob—a time-based scheduler for system jobs.

Event Array—a queue storing actions caught by the Notify Process and handled by the Main Process.

Event Object—stores information pertaining to an “action” detected by the Notify Process.

Event Process—parses event schedule file.

Event-Staged Array—temporary array for saving data associated with a create event

Frame Buffer—a video output device that sends an image or movie to a display.

Inotify—a kernel process that monitoring file system events such as the creation, removal or a modification of a file.

Multi-threading—when a processor switches between different threads.

Main Process—initializes and executes necessary components for the Media player 120, reads and executes file system events caught by the Notify Process

Media Process—renders media content such as images, animated images, and movies to a display.

Media Array—stores media objects that gets rendered to a display by the Media Process.

Media Object—stores information pertaining to a media file such as bytes per pixel, bytes, etc.

Notify Process—listens to file system events, detecting them when they fire and storing these events in a queue for the main thread to handle.

Notifier—provides the interface to the Notifier Process and defines the folders where events occur when a curl may be forwarded to the media player.

Render Object—stores the current state of the playlist as well as the Media Array.

Render Process—iterates the Media Array to facilitate the rendering of Media Objects to a display.

Struct—a type of data structure in which all of its members may be public.

Thread—the smallest type of processing that can be scheduled by the operating system.

Startup scripts—custom jobs, tasks, etc automatically executed by the system on boot.

### Variations of Aspects

As used herein, “consumer” may refer to any potential customer of a business.

It may be understood that the specific order of the components disclosed herein may be examples of exemplary approaches. Based upon design preferences, it may be understood that the specific order components may be rearranged, and/or components may be omitted, while remaining within the scope of the present disclosure unless noted otherwise. The previous description of the disclosed embodiments may be provided to enable any person skilled in the art to make or use the present disclosure. Various modifications to these embodiments may be readily apparent to those skilled in the art, and the generic principles defined herein may be applied to other embodiments without departing from the spirit or scope of the disclosure. Thus, the present disclosure may be not intended to be limited to the embodiments shown herein but may be to be accorded the widest scope consistent with the principles and novel features disclosed herein.

The disclosure may be not intended to be limited to the aspects shown herein, but may be to be accorded the full scope consistent with the specification and drawings, wherein reference to an element in the singular may be not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” may be intended to cover: a; b; c; a and b; a and c; b and c; and a, b and c.

The various illustrative process flows, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In accordance with certain aspects of the present invention, one or more of the process steps described herein may be stored in memory as computer program instructions. These instructions may be executed by a digital signal processor, an analog signal processor, and/or another processor, to perform the methods described herein. Further, the processor(s), the memory, the instructions stored therein, or a combination thereof may serve as a means for performing one or more of the method steps described herein. As used herein, computer program products comprising computer-readable media including all forms of computer-readable medium except, to the extent that such media may be deemed to be non-statutory, transitory propagating signals.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality may be implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In one or more exemplary embodiments, the functions described may be implemented in hardware, software, firmware, or any combination thereof. If implemented in software, the functions may be stored on or encoded as one or more instructions or code on a computer-readable medium, which may be non-transitory. Computer-readable media includes computer storage media. Storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. Any processor and the storage medium may reside in an ASIC. The ASIC may reside in a user terminal. In the alternative, the processor and the storage medium may reside as discrete components in a user terminal.

The previous description of the disclosed embodiments may be provided to enable any person skilled in the art to make or use the present disclosure. Various modifications to these embodiments may be readily apparent to those skilled in the art, and the generic principles defined herein may be applied to other embodiments without departing from the spirit or scope of the disclosure. Thus, the present disclosure may be not intended to be limited to the embodiments shown herein but may be to be accorded the widest scope consistent with the principles and novel features disclosed herein.

Aspects of the present invention may be typically carried out in or resident on a computing network. The computing network generally includes computer hardware components such as servers, monitors, I/O devices, databases, network connection devices, as well as other associated hardware. In addition, the aspects and features described below may include one or more application programs configured to receive, convert, process, store, retrieve, transfer and/or export data and other content and information. As an example, these aspects and features may include one or more processors that may be coupled to a memory space comprising SRAM, DRAM, Flash and/or other physical memory devices. Memory space may be configured to store an operating system (OS), one or more application programs, such as a UI program, data associated with the pertinent aspect or feature, applications running on processors in the device, user information, or other data or content. The various aspects and features of the present invention may further include one or more User I/O interfaces, such as keypads, touch screen inputs, mice, Bluetooth devices or other I/O devices. In addition, the certain aspects and features may include a cellular or other over the air wireless carrier interface, as well as a network interface that may be configured to communicate via a LAN or wireless LAN (WiLAN), such as a Wi-Fi network. Other interfaces, such as USB or other wired interfaces may also be included.

Various aspects of the disclosure may be practiced on general purpose or special purpose computing system environments or configurations. Examples of well-known computing devices, systems, environments, and/or configurations that may be suitable for use with the implementations include, but may be not limited to, personal computers, server computers, hand-held or laptop devices, multiprocessor systems, microprocessor-based systems, programmable consumer electronics, networked PCs, minicomputers, mainframe computers, and distributed computing environments that include any of the above systems or devices, and the like. Accordingly, one or more aspects taught herein may be incorporated into a phone (e.g., a cellular phone or smart phone), a computer (e.g., a laptop or mini laptop), a portable communication device (e.g., “tablet” computing devices), a kiosk device, or any other suitable device that may be configured to communicate via a wireless or wired medium. One or more aspects taught herein may also be incorporated into user input devices (e.g., keyboard, mouse, touch screen, speech recognition) or output devices (e.g., display, audio outputs) implemented to support various aspects described herein.

Various communications networks may be used to carry out certain aspects of the disclosure. The communications networks may be configured to provide communication links between the various subsystems of FIG. 1. Examples of communications links include the Internet, private networks (e.g., virtual private networks or “VPN”s), local area networks (e.g., LAN, WiLAN, Wi-Fi, Bluetooth), cellular, satellite, other wireless communication pathways, and/or other wired communication pathways.

As those skilled in the art may appreciate, various intermediary network routing and other elements between subsystems in FIG. 1 have been omitted for the sake of simplicity. Such intermediary elements may include, for example, the public switched telephone network (PSTN), gateways or other server devices, and other network infrastructure provided by Internet service providers (ISPs). Further, those skilled in the art may also appreciate the various security protocols which may be implemented to protect a user from unscrupulous individuals who may attempt to hijack network communications (e.g., Secured HTTP, encryption).

While various embodiments of the present invention have been described in detail, it may be apparent to those skilled in the art that the present invention can be embodied in various other forms not specifically described herein. Therefore, the protection afforded the present invention should only be limited in accordance with the following claims.

We claim:

1. A system configured to manage digital advertisements among a distributed network of advertising displays at remote locations, the system comprising:
a data source storing advertisement data corresponding to a plurality of advertisements; and
at least one processing component operable to:
select a first remote display at a first location from among a plurality of remote displays corresponding to a plurality of locations;
select a first advertisement from the plurality of advertisements; and
cause the first remote display to display the first advertisement.

2. The system of claim 1, wherein the first location relates to a first business, and wherein the first advertisement is associated with a second business.

3. The system of claim 2, wherein the at least one processing component is operable to:
determine, prior to causing the first remote display to display the first advertisement, if the second business competes with the first business.

4. The system of claim 1, wherein the first advertisement includes a code that is associated with goods or services offered by a business, and wherein the at least one processing component is operable to:
detect whether a consumer used the code to obtain the goods or services offered by the business; and
upon determining that the consumer used the code to obtain the goods or services offered by the business, cause the first remote display to display a second advertisement.

5. The system of claim 1, wherein the at least one processing component is operable to:
determine, prior to selecting the first advertisement and selecting the first remote display, a first position of a consumer;
select the first remote display based on the first position; and
select the first advertisement based on a characteristic of the consumer.

6. The system of claim 1, wherein the at least one processing component is operable to:
track, prior to selecting the first remote display, a consumer's position during a first period of time; and
select the first remote display based on the tracking of the consumer's position during the first period of time.

7. The system of claim 6, wherein the at least one processing component is operable to:
track the consumer's position during a second period of time;
select a second remote display based on the tracking of the consumer's position during the second period of time; and
cause the second remote display to display the first advertisement or a second advertisement based on the tracking of the consumer's position during the second period of time.

8. The system of claim 7, wherein the at least one processing component is operable to:
cause the first remote display to not display the first advertisement based on the tracking of the consumer's position during the second period of time.

9. The system of claim 1, wherein the at least one processing component is operable to:
select the first display based on a detected condition, including the closing of a venue having consumers in attendance.

10. The system of claim 2, wherein the at least one processing component is operable to:
associate a cost to the display of the first advertisement on the first remote display, wherein the cost is a function of one or more factors.

11. A computer-implemented method for managing digital advertisements among a distributed network of advertising displays at remote locations, the method comprising steps to:
identify a first remote display at a first location from among a plurality of remote displays corresponding to a plurality of locations;
identify, using a at least one processing component, a first advertisement from a plurality of advertisements stored in a data source; and
cause the first remote display to display the first advertisement.

12. The system of claim 11, wherein the first location relates to a first business, wherein the first advertisement is associated with a second business, and wherein the at least one processing component is operable to:
determine, prior to causing the first remote display to display the first advertisement, if the second business competes with the first business; and
associate a cost to the display of the first advertisement on the first remote display, wherein the cost is a function of one or more factors.

13. The system of claim 11, wherein the first advertisement includes a code that is associated with goods or services offered by a business, and wherein the at least one processing component is operable to:
select the first display based on a detected condition, including the closing of a venue having consumers in attendance;
detect whether a consumer used the code to obtain the goods or services offered by the business; and
cause, upon determining that the consumer used the code to obtain the goods or services offered by the business, the first remote display to display a second advertisement.

14. The system of claim 11, wherein the at least one processing component is operable to:
track, prior to selecting the first remote display, a consumer's position during a first period of time;
select the first remote display based on the tracking of the consumer's position during the first period of time;
select the first advertisement based on a characteristic of the consumer.
track the consumer's position during a second period of time;
select a second remote display based on the tracking of the consumer's position during the second period of time;
cause the second remote display to display the first advertisement or a second advertisement based on the tracking of the consumer's position during the second period of time; and
cause the first remote display to not display the first advertisement based on the tracking of the consumer's position during the second period of time.
